(19) United States
(12) Patent Application Publication
(10) Pub. No.: US 2018/0326470 A1
(43) Pub. Date: Nov. 15, 2018

(54) METHOD FOR PRODUCING A SLEEVE-LIKE PASSAGE

(71) Applicant: Benteler Automobiltechnik GmbH, Paderborn, DE (US)

(72) Inventors: Sigmund Roe, Gjovik (NO); Lars Erik Vingnesengen, Gjovik (NO)

(21) Appl. No.: 15/973,902

(22) Filed: May 8, 2018

(30) Foreign Application Priority Data
May 10, 2017 (DE) 102017 110 096.2

(51) Int. Cl. B21D 28/24; B60G 7/00; B23P 15/00; B21D 47/01

(52) U.S. Cl. CPC B21D 28/24; B60G 7/001; B23P 15/00; B21D 47/01; B60G 2204/418; B23P 2700/14; B60G 2206/7102; B60G 2206/8105; B60G 2206/83; B60G 2206/8111; B60G 2206/10

(57) ABSTRACT

The disclosure comprises a method for producing a sleeve-like passage for a bearing accommodation in a metallic wheel control arm of a vehicle. The method may include placing a wheel control arm end of the wheel control arm onto a pressing plate of a pressing tool; and forming a tapered wall in the wheel control arm end and a circumferential collar around the tapered wall in the wheel control arm end, wherein the forming comprises pressing the wheel control arm end against the pressing plate using a pressing punch, wherein a volume of metal of the wheel control arm end is displaced into a circumferential cavity due to the pressing of the wheel control arm end against the pressing plate,; and perforating the tapered wall to obtain the sleeve-like passage.

### CROSS-REFERENCE TO RELATED APPLICATIONS

This application claims priority to German patent application No. 10 2017 110 096.2, entitled “VERFAHREN ZUM HERSTELLEN EINES HÜLSENFÖRMIGEN DURCHZUGS”, and filed on May 10, 2017 by the Applicant of this application. The entire disclosure of the German application is incorporated herein by reference for all purposes.

### BACKGROUND

The present disclosure relates to a method for producing a sleeve-like passage for the bearing accommodation, in particular in a wheel control arm of a vehicle, with the aid of a pressing tool.

A sleeve-like passage in a workpiece can be formed, for example, by a punching, drilling, rolling or spreading method. These methods can have the disadvantage that it may be necessary to generate a recess in the material at the beginning of the method. This can relate, in particular, to the rolling or spreading of the workpiece, wherein the recess disadvantageously may be generated in a separate method step before the shaping of the sleeve-like passage. In particular, a punching or drilling method can have the disadvantage that an increased volume of material of the workpiece cannot be used, since a volume of material, in the form of shavings and/or in the form of a punched out part, which can be produced during the drilling or punching, respectively, can be lost.

### SUMMARY

The aim of the present disclosure is to provide an improved method for producing a sleeve-like passage.

This aim is achieved by the features of the independent claims, Advantageous examples of the disclosure are the subject matter of the dependent claims, the description and the appended drawings.

The disclosure is based on the finding that the above aim can be achieved by a process for pressing of at least two form parts arranged on facing side surfaces of a workpiece, wherein the workpiece can be pressed into a first shape by a pressure action onto at least one of the form parts, wherein material of the workpiece is displaced and can follow the shape of the at least one form part. In a subsequent method step, remaining and/or non-reshaped material can be removed, in particular punched out, in order to obtain a second, final shape which forms the sleeve-like passage.

Thereby, the problem of the loss of material in the production of a sleeve-like passage is solved and/or the disadvantage of a multi-step method is avoided, in particular by avoiding the generation of a recess before the process.

According to a first aspect, the disclosure relates to a method for producing a sleeve-like passage for the bearing accommodation in a wheel control arm of a vehicle, with the aid of a pressing tool, wherein the wheel control arm is produced from a metal, wherein the pressing tool has a pressing plate and a circumferential cavity around the pressing plate, with placement of a wheel control arm end of the wheel control arm onto the pressing plate; and pressing of the wheel control arm end against the pressing plate by means of a pressing punch, whereby, due to the pressing of the wheel control arm end against the pressing plate, a volume of metal of the wheel control arm end is displaced into the circumferential cavity, whereby, in the wheel control arm end, a tapered wall and a circumferential collar around the tapered wall are formed; and perforation of the tapered wall in order to obtain the sleeve-like passage.

The pressed plate and the pressed punch together can form an at least partially enclosing form for the wheel control arm, into which the wheel control arm can be introduced. The pressing punch and/or the pressing plate can act by a compressive force on the wheel control arm in order to displace a volume of material, in particular a volume of metal of the wheel control arm. Due to the shape of the pressing punch and/or of the pressing plate, it can be predetermined which shape the displaced volume of metal can assume. The volume of metal can flow along the delimiting surfaces of the pressing plate and/or of the pressing punch. In this way, a reshaping of the volume of metal, in particular a reshaping to form the circumferential collar can be achieved.

After the pressing which, in particular, results in a pressure shaping of the wheel control arm, between the pressing plate and the pressing punch, the tapered wall can be formed, which is delimited by the circumferential collar and/or not reshaped by the pressing. In order to obtain a sleeve-like passage, the tapered wall can be perforated.

Advantageously, the tapered wall can he produced at lower tool cost and/or in a shorter time in comparison to the forming of a perforation in the wheel control arm with a non-tapered wall, so that the manufacturing costs and/or manufacturing time of the sleeve-like passage can he reduced.

A circumferential cavity may be necessary in order to accommodate a displaced volume, in particular the volume of metal, if the material of the wheel control arm is incompressible. The wheel control arm alternatively can be made from a compressible material, so that the presence of a circumferential cavity may not be necessary. A compressible material can also be an incompressible material with inclusions of a compressible medium, in particular a foamed metal or a foamed plastic.

The circumferential cavity can be formed in the pressing tool on one side or on both sides of the wheel control arm. In the case of a two-sided formation, in relation to the wheel control arm, in each case a circumferential cavity is arranged on the side of the pressing punch and on the side of the pressing plate. These circumferential cavities can, in particular, be oriented congruently in particular in the direction of an axis of the sleeve-like passage, which runs transversely to a wheel control arm longitudinal axis. In this manner, relative to a side surface of the wheel control arm facing the pressing punch and relative to a side surface of the wheel control arm facing the pressing plate, a symmetric displacement of the volume of metal into the respective circumferential cavity can he achieved. The circumferential cavities can have different cross sections in order to achieve, on the pressing punch side, a cross-sectional shape of the circumferential collar which is different from the collar shape of the circumferential collar of the pressing plate side.

In addition to wheel control arms, the method according to the disclosure can also he used for other vehicle components in which a sleeve-like passage can he formed. The vehicle components can be manufactured in particular from aluminum and/or formed by extrusion.

In an example, the pressing punch acts exclusively on the wheel control arm end in the direction of the pressing plate.

The volume of material of the wheel control arm end which is arranged under the pressing punch is exposed to a force application, in particular a compressive force application, of the pressing punch. Advantageously, this volume of material can thus be displaced and introduced, in particular, into the circumferential cavity.

In an example, the wheel control arm is formed from a single-piece extruded profile, in particular from an aluminum extruded profile.

In particular, the single-piece production of the wheel control arm results in an efficient force transmission by the wheel control arm, since the number of the mechanical connections and thus also play, friction and/or stress within the wheel control arm can be reduced.

In an example, the perforation of the tapered wall can be brought about by drilling or punching.

A perforation of the tapered wall by drilling can result, in particular, in a smooth front side of the sleeve-like passage. This can in particular result in the introduction of a hearing into the sleeve-like passage with an advantageously reduced force exertion, since the front side can be free of edges and/or bumps, so that the frictional resistance between the bearing and the front side can advantageously be reduced. A secondary smoothing treatment of the front side can be dispensed with, so that the manufacturing cost for the sleeve-like passage can advantageously be reduced.

A perforation of the tapered wall by punching, in comparison to other perforation methods, can be carried out in a shorter time, which achieves the advantage of a reduced production time for the sleeve-like passage. Moreover, during the punching on the front side of the sleeve-like passage, a punching burr can form. This punching burr can increase the friction between a hearing which can be introduced into the sleeve-like passage, so that the firm seating of the bearing in the sleeve-like passage can advantageously be strengthened.

The surface area of the front side can be maximized, in that the inner surface of the sleeve-like passage has no perforations and/or similar defects. This can advantageously increase the firm seating of the bearing in the sleeve-like passage and thus the force transmission onto the wheel control arm.

In an example, a diameter of the sleeve-like passage is identical over a passage depth of the sleeve-like passage, so that, in particular, cylindrically shaped bearings can be accommodated with positive-locking connection in the sleeve-like passage.

In particular, the bearing can be an elastomer bearing without bearing outer sleeve, so that, directly between the elastomer of the elastomer bearing and the front side, a friction locking and/or positive-locking connection can be achieved. Advantageously, the elastomer bearing is pressed into the sleeve-like passage.

In an example, the circumferential collar forms a front side of the sleeve-like passage.

The sleeve-like passage can be delimited at least partially by the front side. In the case of production of the wheel control arm out of a solid material, the front side of the sleeve-like passage can be determined by the material thickness of the wheel control arm and the height of the circumferential collar protruding from the wheel control arm. The height of the circumferential collar can be determined by the volume of material which is displaced by the pressing. Moreover, the circumferential collar can form a flange.

In an example, the circumferential cavity can be delimited at least in sections by a curved delimitation wall in order to prevent a lateral displacement of the volume of metal, wherein a volume of metal is displaced by the pressing punch beyond the circumferential cavity and pressed against the curved delimitation wall, in order to obtain a curved outer wall of the sleeve-like passage.

By means of the curved delimitation wall, the volume of metal can be displaced at least partially transversely to the pressing direction of the pressing punch. Thus, in addition to the circumferential collar, a lateral deformation of the wheel control arm can be achieved. The curved delimitation wall can determine the final shape of the displaced volume of metal. The curved delimitation wall can follow, for example, the curvature of the pressing punch, so that the circumferential collar and the wheel control arm end have a similar curvature in the area of the sleeve-like passage.

In an example, the curved delimitation wall is curved at least in sections in the shape of an arc or in the shape of a circle.

A surface of the pressing punch facing the curved delimitation wall can also be curved in the shape of an arc or in the shape of a circle at least in sections, so that the displaced volume of metal can be reshaped uniformly towards the curved delimitation wall. In accordance with the curvature of the surface of the pressing punch and the curved delimitation wall, in each case the same space for reshaping can be available to the displaced volume of metal along a circular path.

In an example, the wheel control arm end is made to bulge out laterally by displacement of the volume of metal against the curved delimitation wall, in order to increase an outer diameter of the sleeve-like passage transversely to a wheel control arm axis.

The bulging of the wheel control arm end occurs in such a manner that a diameter of the sleeve-like passage and a passage depth of the sleeve-like passage can be increased transversely to the wheel control arm axis beyond the dimensions of the wheel control arm end.

The bulging of the wheel control arm end can produce, in the area of the sleeve-like passage, a broadening of the wheel control arm end transversely to the wheel control arm longitudinal axis. A delimitation of the flared wheel control arm end can be achieved by the curved delimitation wall.

By means of the broadening of the wheel control arm end, the sleeve-like passage can have a diameter which is greater than a cross-sectional width of the wheel control arm end before the bulging, Thus, the wheel control arm can, for example, have a broadening only in the area of the sleeve-like passage, and the remaining portion of the wheel control arm can have a smaller cross-sectional width and/or a smaller cross-sectional area, so that the weight of the wheel control arm and/or the necessary installation space of the wheel control arm can advantageously be reduced.

Due to the bulging, a firm seating and/or the guarantee of a sufficient accuracy of fitting of the sleeve-like passage, which forms, in particular, a bearing sleeve, can be achieved efficiently and cost effectively. Such a wheel control arm can furthermore take up less installation space and/or be produced more cost advantageously.

In an example, the pressing plate forms a flat support, in particular a flat and circular support for the wheel control arm end, wherein, due to the pressing with the pressing punch, the tapered wall assumes the geometric shape of the flap support.

The wheel control arm end can be reshaped by displacement of the volume of metal in accordance with the shape of the pressing plate and of the pressing punch, The pressing plate and the pressing punch can be shaped in particular symmetrically, so that the final shape of the sleeve-like passage after the pressing is also symmetrical. In addition to a rotationally symmetric shape, the pressing punch can have a rectangular shape and/or other shapes which can be composed of curved, straight and/or angular sections.

In an example, the wheel control arm end can be reshaped cold by means of pressing punch.

Thereby, the advantage is achieved that no stresses are introduced into the metal due to heating and subsequent cooling. In particular, the production of the sleeve-like passage can be achieved in a more energy saving and/or more energy efficient manner.

In an example, the wheel control arm has an additional wheel control arm end which is arranged parallel to the wheel control arm end, wherein the method comprises the following steps: placement of the additional wheel control arm end of the wheel control arm onto the pressing plate; and pressing of the additional wheel control arm end against the pressing plate by means of the pressing punch, wherein a volume of metal of the additional wheel control arm end is displaced into the circumferential cavity due to the pressing of the additional wheel control arm end against the pressing plate, whereby a tapered wall and a circumferential collar around the tapered wall are formed in the additional wheel control arm end; and perforation of the tapered wall in order to obtain an additional sleeve-like passage, wherein the sleeve-like passage and the additional sleeve-like passage form a bearing sleeve.

By means of the sleeve-like passage and the additional sleeve-like passage, two connecting elements, in particular two mounted connection points, can be formed in the wheel control arm. In particular, the wheel control arm can be designed to connect a wheel support to a vehicle component via the two connecting elements. The connecting elements can be bearings which are pressed into the respective sleeve-like passage, wherein the respective sleeve-like passage can form a bearing sleeve for the respective bearing. In this manner, advantageously, an additional bearing sleeve can be dispensed with and/or a sleeve-free bearing can be introduced, in particular pressed, into the sleeve-like passage and/or into the additional sleeve-like passage.

The bearing sleeve can have a specific push-out force which can be dependent on the surface area of the front side of the sleeve-like passage, in particular proportional to the surface area of the front side. The front side can form a contact surface for a bearing. Moreover, a lifespan and/or a performance of the connection between the bearing and the front side can be dependent on a contact area between the bearing and the front side. An increased contact area increase the lifespan of the connection between a bearing and the front side and/or increase the performance, in particular the degree of efficiency of the force transmission of this connection.

In an example, the respective wheel control arm end can be placed perforation-free onto the pressing plate without perforation.

For the pressing of the wheel control arm, preceding method steps, in particular a preceding perforation of the wheel control arm end, may not be necessary, so that the displacement of the volume of metal can be achieved in one method step, in particular in the pressing.

In an example, the perforation can he carried out in a perforation process after the pressing process.

Due to the pressing, the tapered wall can be formed between the pressing punch and the pressing plate, wherein this wall was not displaced in the radial direction by the pressing tool. In order to create a perforation, the tapered wall can be removed or displaced by punching, drilling, rolling and/or cutting methods. As cutting devices, blade tools, laser, water jet or plasma cutters can be used in particular.

In an example, the pressing is carried out in a pressing process.

The pressing process can comprise a pressing of the pressing punch onto the wheel control arm end and/or a pressing of the pressing plate onto the wheel control arm end. The pressing punch and the pressing plate each have a surface facing the wheel control arm, wherein the surface normal can in each case be oriented parallel to a surface normal of a surface of the wheel control arm. During the pressing, a force acts along this surface normal, As a result, a volume of metal can he displaced transversely to the surface normal.

The pressure acting on the wheel control arm end during the pressing process can exceed a limit pressure value which determines the pressure starting at which the material of the wheel control arm is plastically deformable, in particular without additional heat exposure.

In the case of a displacement of material, the pressing punch can be tracked continuously in the direction of the acting force during the pressing process, in order to keep the pressure acting on the wheel control arm end constant. A change in the tracking speed in proportion to the speed of the material displacement and thus tapering of the wall can achieve an increase or a reduction of the pressure acting on the wheel control arm end.

According to a second aspect, the disclosure relates to a pressing tool for producing a sleeve-like passage for the bearing accommodation in a wheel control arm of a vehicle, wherein the wheel control arm is produced from a metal, wherein the pressing tool has the following features: a pressing plate on which a wheel control arm end can be placed; a circumferential cavity around the pressing plate; a pressing punch for the pressing of the wheel control arm end against the pressing plate in order to displace a volume of metal of the wheel control arm end into the circumferential cavity and thereby form, in the wheel control arm end, a tapered wall and a circumferential collar around the tapered wall.

In particular, the pressing tool is designed to form the circumferential collar and/or the tapered wall and/or to bulge out the wheel control arm end, wherein additional plastic deformations can be prevented. in particular, due to the pressing process, continuous surfaces can be formed, in particular without cracks and/or defects.

The pressing tool can have an additional circumferential cavity which delimits the pressing punch. The volume of metal can be displaced into the circumferential cavity and into the additional circumferential cavity, so that both on the pressing punch side and also on the pressing plate side, in the wheel control arm end, a circumferential collar can be formed, which can protrude from the wheel control arm end,

The pressing punch and/or the pressing plate can be formed from a material which is harder in comparison to the material of the wheel control arm body, in order to be able to plastically deform the wheel control arm end in an incremental manner. Thereby, a precise forming of the sleeve-like passage in the wheel control arm end can be achieved.

In an example, the circumferential cavity is delimited at least in sections by a curved delimitation wall in order to form a curved outer wall of the sleeve-like passage by pressing by means of the pressing punch.

In an example, the pressing tool comprises a punch for the perforation of the tapered wall.

### BRIEF DESCRIPTION OF THE DRAWINGS

Examples of the present disclosure are explained in further detail in reference to the appended drawings.

FIG. 1 represents a method according to an example;

FIG. 2 represents a pressing tool according to an example; and

FIG. 3 represents a pressing tool according to an example.

### DETAILED DESCRIPTION

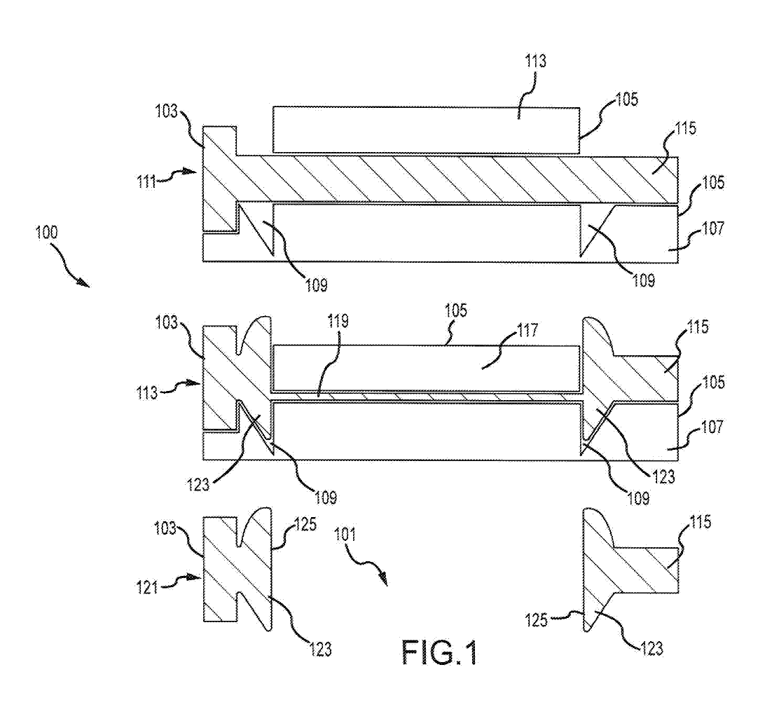

FIG. 1 shows a diagrammatic representation of a method 100 for producing a sleeve-like passage 101 for the bearing accommodation in a wheel control arm 103 of a vehicle, with the aid of a pressing tool 105. The wheel control arm 103 is produced from a metal, and the pressing tool 105 comprises a pressing plate 107 and a circumferential cavity 109 around the pressing plate 107. The method 100 comprises a placement 111 of a wheel control arm end 115 of the wheel control arm 103 onto the pressing plate 107, and a pressing 113 of the wheel control arm end 115 against the pressing plate 107 by means of a pressing punch 117, Due to the pressing 113 of the wheel control arm end 115 against the pressing plate 107, a volume of metal of the wheel control arm end 115 is displaced into the circumferential cavity 109, whereby, in the wheel control arm end 115, a tapered wall 119 and a circumferential collar 123 around the tapered wall 119 are formed, Moreover, the method 100 comprises a perforation 121 of the tapered wall 119 in order to obtain the sleeve-like passage 101. FIG. 1 is a cross-sectional view through the pressing tool 105 and the wheel control arm 103, wherein the wheel control arm longitudinal axis 205 forms a surface normal of the cross-sectional plane.

The circumferential cavity 109 has a triangular cross section and is designed as circular, The pressing punch 117 is also designed as circular, wherein the diameter of the pressing punch 117 is smaller than or equal to the inner diameter of the circumferential cavity 109.

The volume of metal displaced by the pressing 113 of the wheel control arm end 115 against the pressing plate 107 forms the circumferential collar 123 which protrudes on both sides of the sleeve-like passage 101 from the wheel control arm 103. An inner surface of the circumferential collar 123 forms a front side 125 of the sleeve-like passage 101, wherein the front side 125 delimits the sleeve-like passage 101. The front side 125 provides a contact area for introducing a bearing into the sleeve-like passage 101.

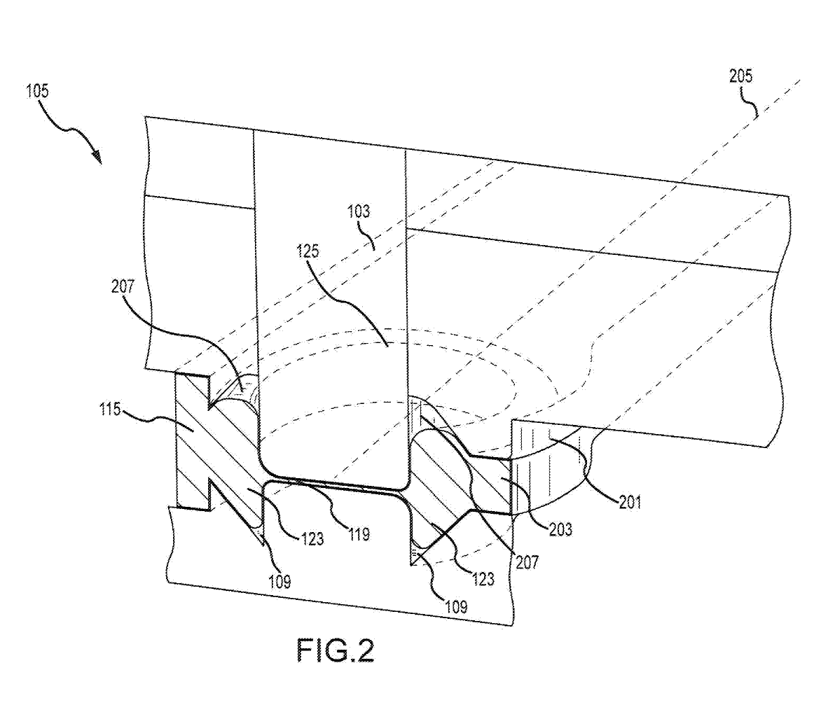

FIG. 2 shows a diagrammatic view of the pressing tool 105 for the production of a sleeve-like passage 101 for the bearing accommodation in a wheel control arm 103 of a vehicle. The pressing tool 105 has a pressing plate 107 onto which a wheel control arm end 115 can be placed. Moreover, the pressing tool 105 comprises a circumferential cavity 109 around the pressing plate 107, and a pressing punch 117 for the pressing 113 of the wheel control arm end 115 against the pressing plate 107, in order to displace a volume of metal of the wheel control arm end 115 into the circumferential cavity 109 and thereby form, in the wheel control arm end 115, a tapered wall 119 and a circumferential collar 123 around the tapered wall 119. A wheel control arm end 115 is placed onto the pressing plate 107. The wheel control arm 103 has a T-shaped cross section along the wheel control arm longitudinal axis 205, wherein the sleeve-like passage 101 is introduced in the long arm of the T-shape.

The circumferential cavity 109 is delimited at least in sections by a curved delimitation wall 201 in order to prevent a lateral displacement of the volume of metal, wherein the volume of metal is displaced by the pressing punch 117 beyond the circumferential cavity 109 and pressed against the curved delimitation wall 201 in order to obtain a curved outer wall 203 of the sleeve-like passage 101.

The curved delimitation wall 201 is curved at least in sections in the shape of an arc or in the shape of a circle.

The wheel control arm end 115 bulges out laterally by a displacement of the volume of metal against the curved delimitation wall 201 in order to increase an outer diameter of the sleeve-like passage 101 transversely to the wheel control arm longitudinal axis 205.

The pressing plate 107 forms a flat and circular support for the wheel control arm end 115, and, due to the pressing 113 with the pressing punch 117, the tapered wall 119 assumes the geometric shape of the flat support.

In the depicted position of the pressing tool 105, the wheel control arm 103 has already been reshaped, so that the volume of metal has been displaced and reshaped to form the circumferential collar 123.

The pressing tool 105 has an additional circumferential cavity 207 which delimits the pressing punch 117. The volume of metal is displaced into the circumferential cavity 109 and the additional circumferential cavity 207, so that both on the pressing punch side and also on the pressing plate side, in the wheel control arm end 115, a circumferential collar 123 is formed, which protrudes from the wheel control arm end 115.

The additional circumferential cavity 207 has a height that decreases continuously with increasing distance from the pressing punch 117, wherein the decrease of the height with respect to the distance from the pressing punch 117 is not linear. In particular, in a first area close to the pressing punch 117, an area with constant height of the additional circumferential cavity 207 is formed.

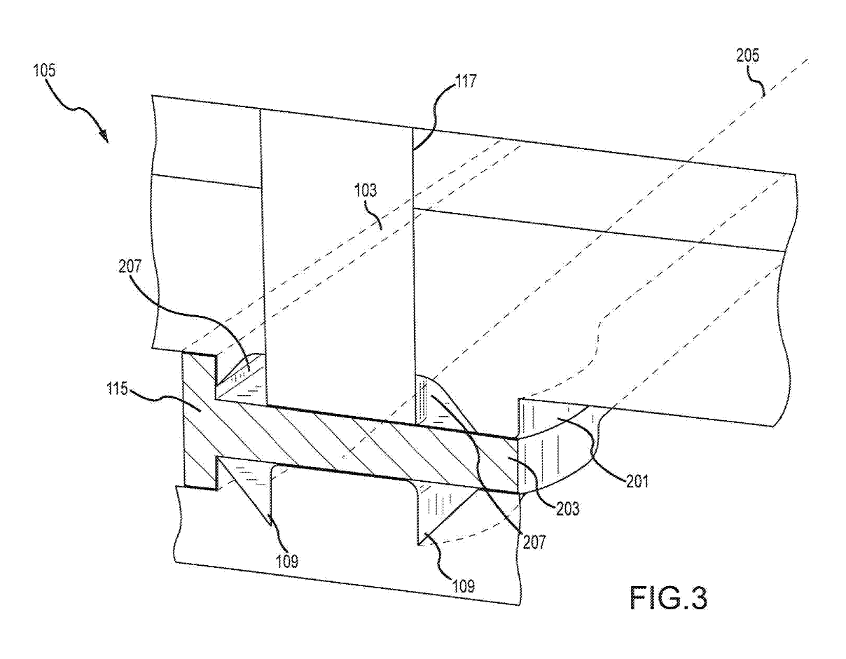

FIG. 3 shows a diagrammatic view of the pressing tool 105 for the production of a sleeve-like passage 101 for the bearing accommodation in a wheel control arm 103 of a vehicle. The pressing tool 105 has a pressing plate 107 onto which a wheel control arm end 115 can be placed. Moreover, the pressing tool 105 has a circumferential cavity 109 around the pressing plate 107, and a pressing punch 117 for the pressing 113 of the wheel control arm end 115 against the pressing plate 107, in order to displace a volume of metal of the wheel control arm end 115 into the circumferential cavity 109 and thereby form, in the wheel control arm end 115, a tapered wall 119 and circumferential a collar 123 around the tapered wall 119.

In the depicted position of the pressing tool 105, the wheel control arm end 115 is placed onto the pressing plate 107, and a subsequent lowering of the pressing punch 117 into the wheel control arm end 115 produces a displacement of the volume of metal, The outer wall 203 is not deformed before the pressing 113, in particular is not curved, so that the wheel control arm end 115 has a rectangular profile.

The circumferential cavity 109 and the pressing punch 117 are designed as circular, wherein the circumferential cavity 109 has an inner diameter which is at least equal to or greater than a diameter of the pressing punch 117. Thus, material of the wheel control arm end 115 is not displaced directly in the direction of the force exertion by the pressing punch 117 into the circumferential cavity 109, but is rather displaced laterally with a thickness reduction of the wheel control arm end 115.

### LIST OF REFERENCE NUMBERS

100 Method

101 Sleeve-like passage

103 Wheel control arm

105 Pressing tool

107 Pressing plate

109 Circumferential cavity

111 Placement

113 Pressing

115 Wheel control arm end

117 Pressing punch

119 Tapered wall

121 Perforation

123 Circumferential collar

125 Front side

201 Curved delimitation wall

203 Outer wall

205 Wheel control arm longitudinal axis

207 Circumferential cavity

What is claimed is:

1. A method for producing a sleeve-like passage for a bearing accommodation in a metallic wheel control arm of a vehicle, comprising:
placing a wheel control arm end of the wheel control arm onto a pressing plate of a pressing tool; and
forming a tapered wail in the wheel control arm end and a circumferential collar around the tapered wall in the wheel control arm end, wherein the forming comprises pressing the wheel control arm end against the pressing plate using a pressing punch of the pressing tool, wherein a volume of metal of the wheel control arm end is displaced into a circumferential cavity around the pressing plate due to the pressing of the wheel control arm end against the pressing plate; and
perforating the tapered wall to obtain the sleeve-like passage,

2. The method according to claim 1, wherein the pressing punch acts on the wheel control arm end in a direction of the pressing plate.

3. The method according to claim 1, wherein the wheel is shaped from a single-piece extruded profile.

4. The method according to claim 3, wherein the single-piece extruded profile is an aluminum extruded profile.

5. The method according to claim 1, wherein perforating the tapered wall comprises drilling or punching the tapered wall.

6. The method according to claim 1, wherein the circumferential collar forms a front side of the sleeve-like passage,

7. The method according to claim 1, wherein the circumferential cavity is delimited at least in sections by a curved delimitation wall configured to prevent a lateral displacement of the volume of metal, and the method further comprises:
displacing a volume of metal beyond the circumferential cavity using the pressing punch; and
pressing the volume of metal against the curved delimitation wall to obtain a curved outer wall of the sleeve-like passage.

8. The method according to claim 7, wherein the curved delimitation wall is curved at least in sections in the shape of an arc or in the shape of a circle.

9. The method according to claim 7, further comprising:
displacing the volume of metal against the curved delimitation wall to increase an outer diameter of the sleeve-like passage transversely to a wheel control arm axis, wherein the wheel control arm bulges out laterally.

10. The method according to claim 1, wherein the pressing plate forms a flat support for the wheel control arm end, and wherein the tapered wall assumes the geometric shape of the flat support due to the pressing with the pressing punch.

11. The method according to claim 10, wherein the flat support comprises a flat and circular support for the wheel control arm end.

12. The method according to claim 1, wherein the wheel control arm end is cold reshaped by the pressing punch.

13. The method according to claim 1, wherein the wheel control arm comprises an additional wheel control arm end arranged parallel to the wheel control arm end, wherein the method further comprises:
placing the additional wheel control arm end of the wheel control arm onto the pressing plate; and
pressing the additional wheel control arm end against the pressing plate using the pressing punch, wherein a volume of metal of the additional wheel control arm end is displaced into the circumferential cavity due to the pressing of the additional wheel control arm end against the pressing plate, whereby an additional tapered wall and an additional circumferential collar around the additional tapered wall are formed in the additional wheel control arm end; and
perforating the tapered wall to obtain an additional sleeve-like passage, wherein the sleeve-like passage and the additional sleeve-like passage each form a bearing sleeve.

14. The method according to claim 1, wherein the respective wheel control arm end is placed onto the pressing plate without perforation.

15. The method according to claim 1, wherein the pressing is carried out in a pressing process.

16. The method according to claim 15, wherein the perforation is carried out in a perforation process after the pressing process.

17. A pressing tool for producing a sleeve-like passage for a bearing accommodation in a metallic wheel control arm of a vehicle, comprising:
a pressing plate configured for placement of the wheel control arm;
a circumferential cavity around the pressing plate;
a pressing punch configured to press a wheel control arm end against the pressing plate to displace a volume of metal of the wheel control arm end into the circumferential cavity to form, in the wheel control arm end, a tapered wall and a circumferential collar around the tapered wall.

18. The pressing tool according to claim 17, wherein the circumferential cavity is delimited at least in sections by a curved delimitation wall to shape a curved outer wall of the sleeve-like passage by pressing the pressing punch.

19. The pressing tool according to claim 17, further comprising:
a punch configured to perforate the tapered wall.

20. The pressing tool according to claim 17, wherein the circumferential collar forms a front side of the sleeve-like passage
